(19) United States
(12) Patent Application Publication
(10) Pub. No.: US 2014/0210717 A1
(43) Pub. Date: Jul. 31, 2014

(54) HIGH-SENSITIVITY INPUT DEVICE

(71) Applicant: ROKHED, INC., Lafayette, CA (US)

(72) Inventors: Joseph D. Hoover, JR., Lafayette, CA (US); Ron Friedmann, Lafayette, CA (US)

(73) Assignee: ROKHED, INC., Lafayette, CA (US)

(21) Appl. No.: 13/753,560

(22) Filed: Jan. 30, 2013

(51) Int. Cl. G06F 3/0338

(52) U.S. Cl. CPC G06F 3/0338
USPC 345/161

(57) ABSTRACT

An input device includes a base, a handle and a motion sensor. The handle is configured to be gripped by a hand of a user and moved relative to the base. The motion sensor is fitted in an interior of the handle and is configured to translate a movement of the handle by the user into one or more electrical signals.

### FIELD OF THE INVENTION

The present invention relates generally to input devices for electronic systems, and particularly to methods and systems for providing high-sensitivity user input.

### BACKGROUND OF THE INVENTION

Various types of electronic systems use input devices such as joysticks and thumb-sticks for obtaining user input. Input devices of this sort are used, for example, in gaming consoles, aircraft cockpits and flight simulators, military simulators and weapons systems, video surveillance systems, industrial machine control, automotive and other vehicular systems such as steering control, robotics, remote radio control, computer interfaces, electric wheelchairs and many others.

### SUMMARY OF THE INVENTION

An input device includes a base, a handle and a motion sensor. The handle is configured to be gripped by a hand of a user and moved relative to the base. The motion sensor is fitted in an interior of the handle and is configured to translate a movement of the handle by the user into one or more electrical signals.

In some embodiments, the input device includes a shaft that is fixed to the base, and the handle is hollow, at least partially surrounds the shaft and is moved relative to the shaft. In an embodiment, the shaft includes a cup-shaped socket, the motion sensor includes a sensor body that is fixed to the handle and a half-sphere-shaped arm that is placed inside the cup-shaped socket, and the movement of the handle relative to the shaft causes the cup-shaped socket to move the half-sphere-shaped arm relative to the sensor body.

In another embodiment, the motion sensor is fitted in a section of the handle that is gripped by the hand of the user. In yet another embodiment, the input device includes a mechanical interface that is configured to apply motion to the motion sensor in response to the movement of the handle, such that angular motion of no more than twelve degrees of the handle relative to a center position of the handle produces a full range of motion of the motion sensor.

In still another embodiment, the input device includes an additional motion sensor, which is fitted on top of the handle for manipulation by a thumb of the hand of the user. Additionally or alternatively, the input device may include a trigger, which is fitted on top of the handle for pressing by an index finger of the hand of the user, and which produces an analog indication of a pressure applied to the trigger. The trigger may be switchable between producing the analog indication and producing a binary indication of the pressure.

In some embodiments, the input device includes a secondary trigger, which is fitted on top of the handle for actuation by outward pressing of an index finger of the hand of the user, and which is adjustable to suit a length of the index finger. In a disclosed embodiment, the input device includes at least one gaming control pad that is fitted on a same side of the handle as a thumb of the hand of the user.

In an embodiment, the input device includes a display unit fitted in the base. In some embodiments, the input device includes an additional handle that is configured to be gripped by the user and moved relative to the base, and an additional motion sensor that is fitted in the interior of the additional handle and is configured to translate the movement of the additional handle by the user into one or more additional electrical signals.

There is additionally provided, in accordance with an embodiment of the present invention, an input device including a base, a handle and a motion sensor. The handle is configured to be gripped by a hand of a user and moved relative to the base. The motion sensor is fitted in an inner volume formed by the hand of the user and is configured to translate a movement of the handle by the user into one or more electrical signals.

There is also provided, in accordance with an embodiment of the present invention, an input device including a base, a handle, a motion sensor and a mechanical interface. The handle is configured to be moved by a user relative to the base. The motion sensor is configured to translate a movement of the handle relative to the base into one or more electrical signals. The mechanical interface is configured to apply motion to the motion sensor in response to the movement of the handle, such that angular motion of no more than twelve degrees of the handle relative to a center position of the handle produces a full range of motion of the motion sensor.

There is further provided, in accordance with an embodiment of the present invention, an electronics system including an input device and a processor. The input device includes a base, a handle and a motion sensor. The handle is configured to be gripped by a hand of a user and moved relative to the base. The motion sensor is fitted in an interior of the handle and is configured to translate a movement of the handle by the user into one or more electrical signals. The processor is configured to receive the electrical signals from the input device and to act upon the received electrical signals.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a dual-joystick input device, in accordance with an embodiment of the present invention;

FIG. 2 is a diagram showing a vertical cross-section of a joystick, in accordance with an embodiment of the present invention;

FIGS. 3A and 3B are diagrams showing vertical cross-sections of a joystick at two steering positions, in accordance with an embodiment of the present invention;

FIG. 4 is a block diagram that schematically illustrates an electronic system that comprises a high-sensitivity input device, in accordance with an embodiment of the present invention; and

FIGS. 5 and 6 are schematic pictorial illustrations of dual-joystick input devices, in accordance with embodiments of the present invention.

### DETAILED DESCRIPTION OF EMBODIMENTS

### Overview

A typical input device comprises a handle that is manipulated by a user relative to a base, and a motion sensor that translates the handle movements into one or more electrical signals. In a joystick, for example, the user typically grips the handle with his hand and moves the handle using wrist movements. In a thumb-stick, the user typically manipulates a lever with his thumb.

Embodiments of the present invention that are described herein provide improved input device configurations. In the disclosed embodiments, the motion sensor of the input device is fitted in the interior of the handle, rather than on or below the base. In an example embodiment the motion sensor is fitted in the upper part of the handle, inside the section of the handle that is gripped by the user's hand. Positioning the motion sensor in this manner enables a small length of travel of the handle to apply large angular motion to the motion sensor of the input device. The maximum angle movement and/or the maximum travel distance of the handle relative to its center position is referred to herein as the sensitivity of the input device.

In an example implementation, a joystick comprises a fixed internal shaft that is surrounded by a substantially hollow handle. The handle is gripped and moved by the user's hand relative to the shaft, and thus relative to the base. The motion sensor body is attached to the hollow handle, and the motion sensor arm is coupled mechanically to the fixed internal shaft. In this configuration, small movements of the handle are translated to large angular motions of the motion sensor arm. This example implementation is described in detail further below. The disclosed techniques, however, are not limited to this specific implementation, and any other suitable configuration can also be used in alternative embodiments.

The high sensitivity of the disclosed input devices provides enhanced ergonomics, since only small movements of the user's hand are required in order to obtain the desired input. The disclosed techniques enable a joystick, for example, to achieve sensitivities that were previously only achievable with thumb-sticks. This sort of performance is highly desirable, for example, in gaming console applications.

In addition, the disclosed input device configurations provide smooth operation and thus improved user experience. This performance is provided by a mechanical design that comprises a small number of parts and lends itself to straightforward mass production.

High-Sensitivity Input Device Configurations

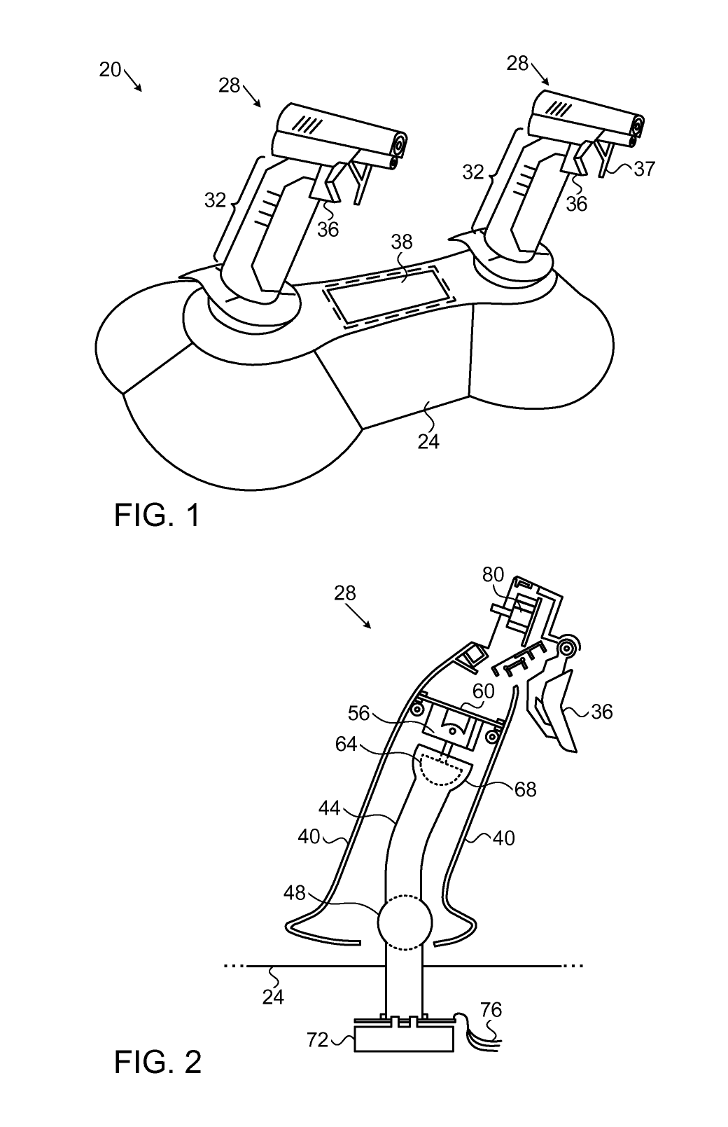

FIG. 1 is a schematic, pictorial illustration of a dual-joystick input device 20, in accordance with an embodiment of the present invention. In the present example, input device 20 is used for providing user input to a gaming console, such as a Microsoft® Xbox® or Xbox360®, Sony® PlayStation® such as PS3, Nintendo® Wii™ or any other suitable console. In other embodiments, input device 20 can be used to control games in other platforms, such as various personal computers, laptop or tablet computers, as well as smartphones.

In alternative embodiments, input devices based on the disclosed techniques can be used with various other systems and in various other applications, such as in aircraft cockpits and flight simulators, military simulators and weapons systems, video surveillance systems, industrial machine control, automotive and other vehicular systems, robotics, computer interfaces, electric wheelchairs and remote radio control, among others.

In the embodiment of FIG. 1, input device 20 comprises a base 24, and two joysticks 28 that are mounted on the base. Each joystick 28 is implemented using the disclosed techniques. This sort of configuration enables a user to operate the console using both hands. The methods and systems described herein, however, are not limited to dual-joystick configurations. For example, the input device may comprise a single joystick.

Each joystick 28 comprises a handle 32, which is gripped by a user's hand. The user typically provides input by moving handle 32 in one or more dimensions (e.g., backward-forward, left-right and any other intermediate angle) relative to the base. The input device translates the handle movements into one or more electrical signals that are provided to the gaming console for processing. In some embodiments, some processing may be performed in input device 20 before the signals are provided to the console.

In some embodiments, although not necessarily, joystick 28 comprises additional controls such as a trigger 36, use of which can provide additional input. Additional types of controls that may be fitted on joystick 28 are addressed further below. In the example of FIG. 1, the input device comprises a display, for example a Liquid Crystal Display (LCD) 38, for displaying any suitable game-related or other information. The LCD may be tilted relative to the surface of base 24 for easy viewing.

Additionally or alternatively, one or more pushbuttons or other controls may be mounted in the area occupied by LCD 38. See, for example, FIG. 5 below. This implementation creates an input device that is similar to what is sometimes referred to as a “fighting stick.”

In some embodiments, the mechanisms of trigger 36 in joysticks 28 comprise Left Bumper (LB) and Right Bumper (RB) controls, also referred to as secondary triggers. To access the LB and RB controls, the user flicks his or her forefinger (index finger) outward to press a switch 37. This configuration allows the user to quickly pull triggers 36 using the forefingers and flick the fingers out to access the secondary triggers 37.

This configuration of the secondary triggers is ergonomically advantageous, because the user's forefinger does not have to reach upward in order to depress the secondary trigger. This arrangement also allows the user a faster response time, both to press the secondary trigger and to return the forefinger to the primary trigger. In an embodiment, the secondary triggers are adjustable, e.g., slide along the bottom barrel of the joystick to adjust for different user finger lengths.

FIG. 2 is a diagram showing a vertical cross-section of joystick 28, in accordance with an embodiment of the present invention. In this embodiment, joystick 28 comprises an internal shaft 44 that is fixed to or below base 24, and a substantially hollow handle 40 that surrounds shaft 44 and is gripped by the user's hand. (Handle 40 corresponds generally to handle 32 in FIG. 1 above.)

In an example embodiment, handle 40 moves relative to shaft 44 using a ball joint, which comprises a ball 48 fitted in a suitable socket. Ball 48 is typically part of shaft 44, and the socket is typically part of handle 40. Alternatively, handle 40 may move relative to shaft 44 using any other suitable joint or other means.

Joystick 28 comprises a motion sensor that is configured to translate the two-dimensional movement of handle 40 relative to shaft 44 into one or more electrical signals. The motion sensor typically comprises a two-dimensional potentiometer. The motion sensor in FIG. 2 comprises a sensor body 56 and an arm or stud 64. Body 56 of the potentiometer is fixed to handle 40, e.g., using a Printed Circuit Board (PCB) 60. The angular position of stud 64 relative to body 56, in two dimensions, sets the resistances of the potentiometer.

The resistances are in turn converted into electrical signals that are indicative of the angular motion or position of stud 64 with respect to body 56. The electrical signals from each joystick 28 are output to a motherboard (not shown, typically located in base 24) over an electrical cable 76. From the motherboard, possibly following some processing, the signals are transmitted to the console or computer over a suitable cable, a wireless connection or using any other suitable means.

Stud 64 of the motion sensor is coupled mechanically to shaft 44, such that the two-dimensional motion of handle 40 relative to shaft 44 translates to two-dimensional angular motion of stud 64 relative to body 56. In the present example, the end of stud 64 has a shape of a half-sphere or mushroom. The half-sphere-shaped end of stud 64 is placed inside a cup-shaped socket 68 (referred to as “cup” for brevity) at the end of shaft 44.

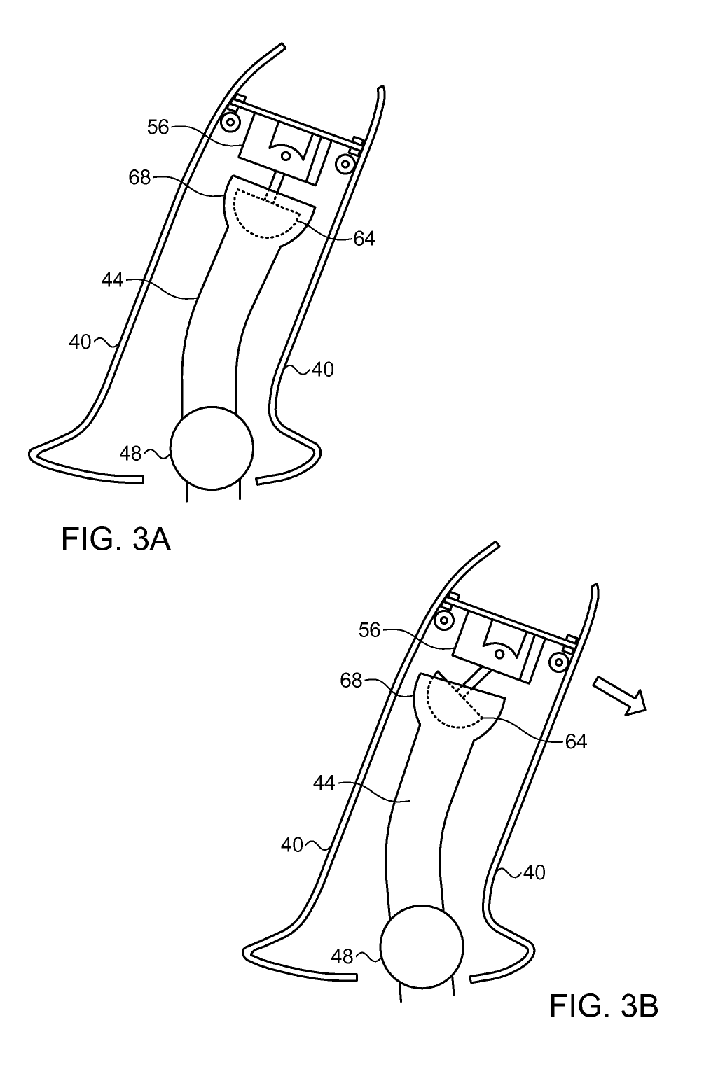

When handle 40 moves with respect to shaft 44, cup 68 moves stud 64 with respect to body 56. The operation of the mechanical interface formed by cup 68 and stud 64 is demonstrated in FIGS. 3A and 3B below.

As can be seen in the figure, the motion sensor is fitted inside the upper section of handle 40, in the section of the handle that is gripped by the user's hand. In other words, when the user grips handle 40, the user's fingers surround or encompass a certain volume. The motion sensor is positioned in that volume.

The joystick configuration shown in FIG. 2 is an example configuration, which is chosen purely for the sake of conceptual clarity. In alternative embodiments, any other suitable configuration can be used. For example, body 56 of the motion sensor can be attached to internal shaft 44 instead of to handle 40, such that body 56 is affixed to internal shaft 44 and stud 64 is affixed to handle 40. The mechanical interface between the internal shaft and the handle can be implemented using any suitable means, not necessarily using a ball joint. The mechanical interface between the motion sensor and the shaft can also be implemented using any suitable means, not necessarily using a cup and stud mechanism. Handle 40 may surround shaft 44 only partially.

As another example, in some implementations handle 40 may move in one dimension only, not necessarily in two dimensions as in the embodiment of FIG. 2. As yet another example, in alternative embodiments the motion sensor may comprise an optics-based motion sensor instead of a potentiometer. An optics-based motion sensor typically comprises a light source and one or more optical detectors. The detectors detect the light emitted by the light source and thus measure the motion of the light source relative to the detectors. As another example, in alternative embodiments the motion sensor may comprise a magnetic motion sensor that senses the motion of one or more magnets relative to one or more magnetic field detectors. Implementing joystick 28 using an optics-based or a magnetic motion sensor would typically involve modifications in the mechanical configuration of the joystick relative to the implementation of FIG. 2.

In some embodiments, joystick 28 may comprise additional controls that enable the user to provide additional input. For example, joystick 28 may comprise a trigger 36 that is typically operated by the user's index finger. Trigger 36 may comprise a switch that provides binary (“pressed”/“not pressed”) input, or an analog trigger that provides analog input indicative of the extent of pressure applied to the trigger. In some embodiments, trigger 36 may be switched between a binary trigger and an analog trigger, for example to suit different requirements of different games.

As another example, joystick 28 may comprise a twist sensor 72 that detects twisting of the joystick (i.e., rotation of the joystick about its longitudinal axis). Further additionally or alternatively, joystick 28 may comprise a miniature thumb-stick 80, which is manipulated in one or two dimensions by the user's thumb.

FIGS. 3A and 3B are diagrams showing vertical cross-sections of joystick 28 at two positions, in accordance with an embodiment of the present invention. Shaft 44, which is attached to the base, is fixed in the same position in both figures. Handle 40 is positioned at a center position in FIG. 3A. In FIG. 3B, handle 40 is positioned at an extreme position to the right (in the direction of the arrow).

The two figures demonstrate the translation of the handle movement into angular motion of the motion sensor. In FIG. 3A, the position of handle 40 causes the motion sensor to be centered relative to shaft 44. Stud 64 is centered relative to cup 68. In this position, cup 68 does not move stud 64 with respect to body 56 of the potentiometer, and the potentiometer arm is therefore centered relative to body 56.

Conversely, in FIG. 3B, the position of handle 40 causes the motion sensor to be displaced off-center to the right relative to shaft 44. As a result, cup 68 makes contact with stud 64 and moves the stud to the left. As can be seen in the figure, the potentiometer arm is set at an angle relative to body 56.

FIGS. 3A and 3B demonstrate the effectiveness of positioning the motion sensor inside the handle, and particularly in the section of the handle that is gripped by the user's hand. When the motion sensor is positioned in this manner, the sensitivity of joystick 28 is high: A small lateral movement of handle 40 is translated into a relatively large angular motion of the motion sensor arm (stud 64). In the present context, the maximum angle movement of handle 40 and/or the maximum travel distance of handle 40 (both measured relative to the handle center position) are referred to herein as the sensitivity of the input device.

In some embodiments, the joystick sensitivity is such that the joystick can produce the full range of motion of the motion sensor by moving joystick handle 40 by an approximate maximum of eight to twelve degrees in any direction, relative to its center position. In an example implementation, a 4-inch handle, measured from center axis to the bottom of trigger 36, with a maximum angular movement of twelve degrees, will have a maximum travel distance of approximately seven-eighths of an inch. With a maximum angular movement of eight degrees, the 4-inch handle will have a maximum travel distance of approximately five-eighths of an inch. Such a configuration will produce the full range of motion of the potentiometer.

The angles and travel distances given above cannot be achieved with a mechanical motion sensor that is positioned on or below base 24. The value ranges above are given purely by way of example, and any other values can be used in alternative embodiments. In some embodiments, the joystick sensitivity can be adjusted, for example to match user preferences. Sensitivity adjustment can be performed, for example, by changing the height of the motion sensor inside the handle.

High joystick sensitivity is important in various applications. In gaming applications, for example, it is important to reduce user hand movements as much as possible, in order to avoid orthopedic damage to the thumb, wrist or other organs.

Moreover, conventional gaming consoles often use thumb-sticks instead of joysticks because of the high sensitivity required. Extensive repetitive use of thumb-sticks, however, may cause thumb stress and fatigue, carpal tunnel pain and other undesired effects. The disclosed techniques are able to achieve the desired sensitivity using a joystick instead of thumb-stick, and thus avoid the undesired phenomena associated with extensive thumb-stick use. Furthermore, the disclosed joystick configurations provide highly smooth travel of the handle, and thus improved user experience.

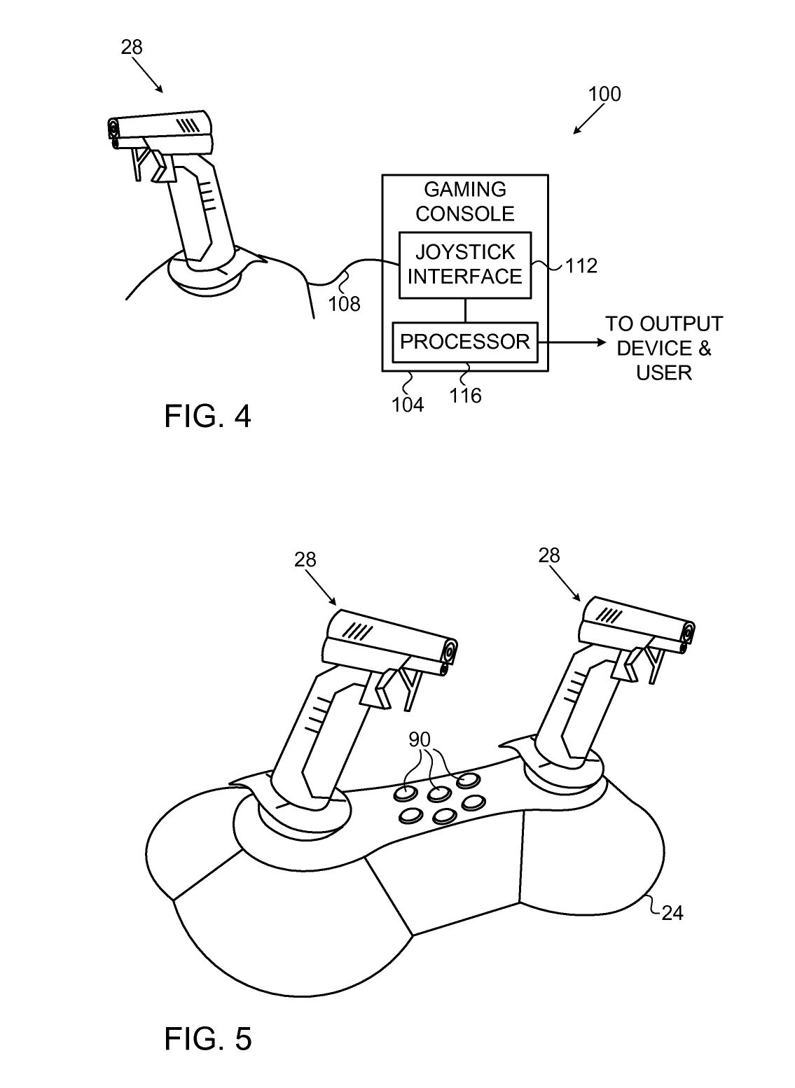

FIG. 4 is a block diagram that schematically illustrates an electronic system 100 that comprises a high-sensitivity input device such as joystick 28, in accordance with an embodiment of the present invention. In the present example, system 100 comprises a gaming console 104 or computer. In alternative embodiments, as noted above, system 100 may comprise any other suitable type of system that involves user input or control, such as an aircraft cockpit, a flight simulator or military simulator, a video surveillance system that steers a video camera, an industrial machine control system, an automotive system, a robotics system or a remote radio control system.

In the embodiment of FIG. 4, console 104 is connected to joystick 28 by a cable 108. Console 104 comprises a joystick interface 112 that receives the electrical signals from joystick 28, and a processor 116 that processes and acts upon the received electrical signals. The processing and actions performed by processor 116 differ from one application to another. In a gaming console, the processor runs some video game that is played and controlled by the user using joystick 28.

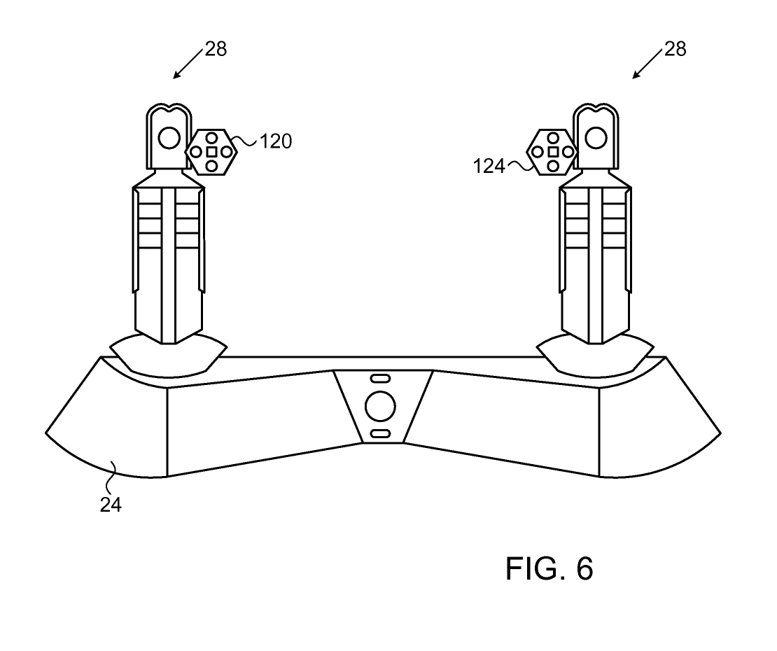

FIGS. 5 and 6 are schematic pictorial illustrations of dual-joystick input devices, in accordance with embodiments of the present invention. FIG. 5 shows a “fighting stick” configuration in which multiple pushbuttons 90 are mounted on base 24. FIG. 6 shows a possible back view of the dual-joystick input device of FIG. 1 or FIG. 5, in which gaming control pads 120 and 124 are fitted on joysticks 28. Each gaming control pad comprises one or more buttons or other control elements.

As can be seen in FIG. 6, control pads 120 and 124 are placed to the inside of the joysticks, i.e., on the same sides of the joysticks as the user's thumbs. Control pads 120 and 124 can therefore be accessed by the natural position of the thumb when the user's hands form a grip around handle 40. This positioning is ergonomically beneficial for thumb placement, designed to reduce thumb movement, stress and fatigue.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. An input device, comprising:
a base;
a handle, which is configured to be gripped by a hand of a user and moved relative to the base; and
a motion sensor, which is fitted in an interior of the handle and is configured to translate a movement of the handle by the user into one or more electrical signals.

2. The input device according to claim 1, and comprising a shaft that is fixed to the base, wherein the handle is hollow, at least partially surrounds the shaft and is moved relative to the shaft.

3. The input device according to claim 2, wherein the shaft comprises a cup-shaped socket, wherein the motion sensor comprises a sensor body that is fixed to the handle and a half-sphere-shaped arm that is placed inside the cup-shaped socket, and wherein the movement of the handle relative to the shaft causes the cup-shaped socket to move the half-sphere-shaped arm relative to the sensor body.

4. The input device according to claim 1, wherein the motion sensor is fitted in a section of the handle that is gripped by the hand of the user.

5. The input device according to claim 1, and comprising a mechanical interface that is configured to apply motion to the motion sensor in response to the movement of the handle, such that angular motion of no more than twelve degrees of the handle relative to a center position of the handle produces a full range of motion of the motion sensor.

6. The input device according to claim 1, and comprising an additional motion sensor, which is fitted on top of the handle for manipulation by a thumb of the hand of the user.

7. The input device according to claim 1, and comprising a trigger, which is fitted on top of the handle for pressing by an index finger of the hand of the user, and which produces an analog indication of a pressure applied to the trigger.

8. The input device according to claim 7, wherein the trigger is switchable between producing the analog indication and producing a binary indication of the pressure.

9. The input device according to claim 1, and comprising a secondary trigger, which is fitted on top of the handle for actuation by outward pressing of an index finger of the hand of the user, and which is adjustable to suit a length of the index finger.

10. The input device according to claim 1, and comprising at least one gaming control pad that is fitted on a same side of the handle as a thumb of the hand of the user.

11. The input device according to claim 1, and comprising a display unit fitted in the base.

12. The input device according to claim 1, and comprising an additional handle that is configured to be gripped by the user and moved relative to the base, and an additional motion sensor that is fitted in the interior of the additional handle and is configured to translate the movement of the additional handle by the user into one or more additional electrical signals.

13. An input device, comprising:
a base;
a handle, which is configured to be gripped by a hand of a user and moved relative to the base; and
a motion sensor, which is fitted in an inner volume formed by the hand of the user and which is configured to translate a movement of the handle by the user into one or more electrical signals.

14. The input device according to claim 13, wherein the handle is hollow, and wherein the motion sensor is fitted in an interior of the handle.

15. The input device according to claim 13, and comprising a shaft that is fixed to the base, wherein the handle is hollow, at least partially surrounds the shaft and is moved relative to the shaft.

16. The input device according to claim 15, wherein the shaft comprises a cup-shaped socket, wherein the motion sensor comprises a sensor body that is fixed to the handle and a half-sphere-shaped arm that is placed inside the cup-shaped socket, and wherein the movement of the handle relative to the shaft causes the cup-shaped socket to move the half-sphere-shaped arm relative to the sensor body.

17. The input device according to claim 13, and comprising a mechanical interface that is configured to apply motion to the motion sensor in response to the movement of the handle, such that angular motion of no more than twelve degrees of the handle relative to a center position of the handle produces a full range of motion of the motion sensor.

18. An input device, comprising:
a base;
a handle, which is configured to be moved by a user relative to the base;
a motion sensor, which is configured to translate a movement of the handle relative to the base into one or more electrical signals; and
a mechanical interface, which is configured to apply motion to the motion sensor in response to the movement of the handle, such that angular motion of no more than twelve degrees of the handle relative to a center position of the handle produces a full range of motion of the motion sensor.

19. The input device according to claim 18, wherein the handle is hollow, and wherein the motion sensor is fitted in an interior of the handle.

20. The input device according to claim 18, wherein the motion sensor is fitted in an inner volume formed by the hand of the user.

21. An electronics system, comprising:
an input device, comprising:
a base;
a handle, which is configured to be gripped by a hand of a user and moved relative to the base; and
a motion sensor, which is fitted in an interior of the handle and is configured to translate a movement of the handle by the user into one or more electrical signals; and
a processor, which is configured to receive the electrical signals from the input device and to act upon the received electrical signals.
